(19) United States
(12) Patent Application Publication
(10) Pub. No.: US 2016/0104901 A1
(43) Pub. Date: Apr. 14, 2016

(54) METHOD FOR MAKING COMPLEX BIPOLAR PLATES FOR FUEL CELLS USING EXTRUSION

(71) Applicants: Daimler AG, Stuttgart (DE); Ford Motor Company, Dearborn, MI (US)

(72) Inventors: Wayne Dang, Burnaby (CA); Robert Esterer, North Vancouver (CA); Robert Artibise, Vancouver (CA); Gary T. Martini, Dexter, MI (US)

(21) Appl. No.: 14/870,344

(22) Filed: Sep. 30, 2015

Related U.S. Application Data
(60) Provisional application No. 62/062,866, filed on Oct. 11, 2014.

(51) Int. Cl. H01M 8/02

(52) U.S. Cl. CPC H01M 8/0258

(57) ABSTRACT

Improved bipolar plates comprising complex features can be manufactured for fuel cells in a simple, low cost manner by starting with an appropriate extruded piece. The complex features include one or more fluid ports which connect to channels internal to the bipolar plate. The method includes extruding a continuous sheet with appropriate linear channels on each surface of the sheet as well as within the sheet, transversely cutting the sheet, machining a fluid port or ports through the sheet to intersect with appropriate internal linear channels, machining at least two sealing ports through the sheet to intersect with the internal linear channels on opposite sides of the fluid ports, and applying sealant into the sealing ports in order to make appropriate seals to the internal linear channels.

### BACKGROUND

1. Field of the Invention

This invention relates to methods for making bipolar plates for fuel cells and particularly for solid polymer electrolyte fuel cells intended for applications requiring high power density.

2. Description of the Related Art

Fuel cells electrochemically convert fuel (e.g. hydrogen) and oxidant (e.g. oxygen or air) to generate electric power. Several types of fuel cells are known and each offers certain advantages and disadvantages depending on the intended power application. Solid polymer electrolyte fuel cells (also known as proton exchange membrane fuel cells) operate at relatively low temperatures and are particularly suitable for consideration in automotive applications. Solid polymer electrolyte fuel cells generally employ a proton conducting, solid polymer membrane electrolyte between cathode and anode electrodes. A structure comprising a solid polymer membrane electrolyte sandwiched between these two electrodes is known as a membrane electrode assembly (MEA). A typical MEA also comprises gas diffusion layers (GDLs) adjacent the electrodes and may comprise additional layers depending on MEA design. The electrodes themselves typically comprise a catalyst (e.g. Pt) to promote the desired electrochemical reactions. In many embodiments, the cathode and anode electrodes are coated directly onto the membrane electrolyte during preparation. Such an assembly is known as a catalyst coated membrane (CCM).

In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications in order to provide a higher output voltage. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates of the cells in the stacks. The coolant flow fields may be formed on the electrochemically inactive surfaces of the flow field plates and thus can distribute coolant evenly throughout the cells while keeping the coolant reliably separated from the reactants.

Bipolar plate assemblies comprising an anode flow field plate and a cathode flow field plate which have been bonded and appropriately sealed together so as to form a sealed coolant flow field between the plates are thus commonly employed in the art. Various transition channels, ports, ducts, and other complex features involving all three operating fluids (i.e. fuel, oxidant, and coolant) may also appear on the inactive side and other inactive areas of these plates. The operating fluids may be provided under significant pressure and thus all the features in the plates have to be sealed appropriately to prevent leaks between the fluids and to the external environment. A further requirement for bipolar plate assemblies is that there is a satisfactory electrical connection between the two plates. This is because the substantial current generated by the fuel cell stack must pass between the two plates.

The plates making up the assembly may optionally be metallic and are typically produced by stamping the desired features into sheets of appropriate metal materials (e.g. certain corrosion resistant stainless steels). Two or more stamped sheets are then typically welded together so as to appropriately seal all the fluid passages from each other and from the external environment. Additional welds may be provided to enhance the ability of the assembly to carry electrical current, particularly opposite the active areas of the plates. Metallic plates may however be bonded and sealed together using adhesives. Corrosion resistant coatings are also often applied before or after assembly.

The plates making up the bipolar plate assembly may also optionally be carbonaceous and are typically produced by molding features into plates made of appropriate moldable carbonaceous materials (e.g. polymer impregnated expanded graphite). Such plates are frequently sealed together using elastomeric contact seals with the entire stack being held under a compression load applied by some suitable mechanical means. More recently, bipolar plate assemblies are being prepared using adhesives that are capable of withstanding the challenging fuel cell environment.

Hybrid bipolar plate assemblies have also been contemplated in the art in which the components making up the assemblies comprise different materials. For instance, US20050244700 discloses a hybrid bipolar plate assembly which comprises a metallic anode plate and a polymeric composite cathode plate.

Unfortunately, fuel cell stacks are typically complicated and costly devices to assemble. Yet reducing cost is one of the remaining challenges before many viable fuel cell products can be introduced commercially. However, all the aforementioned bipolar plate embodiments require the forming of two complex parts (plates), which then must be carefully aligned and bonded together. All these operations involve significant tooling, manufacturing complexity, and hence cost. Further, these bipolar plate assemblies inherently have a contact resistance between the two bonded plates which must always be considered and kept to a minimum.

And depending on which approach is used, there can be other disadvantages with the aforementioned bipolar plate embodiments. For instance, the manner in which metallic plates are created (i.e. stamping of thin sheets) necessarily results in channels on one side of the plate being complementary to those on the other side. Thus, coolant channel and reactant channel (either fuel or oxidant) geometries cannot be made independently. This can be a disadvantage in optimizing fuel cell design. Also for instance, in bipolar plate assemblies comprising molded carbonaceous plates, gaps can exist in certain areas between the anode and cathode plates. In some cases, an excessive gap can lead to plate cracking when the plates are under compression.

A possible approach to address some of these problems involves extruding bipolar plates as a single part. US20050164070 discloses such an approach in which linear flow channels can be formed for the reactants on the outer surfaces of the bipolar plate along with linear cooling flow channels through the centre of the bipolar plate. While the formation of certain other features is disclosed, no means are disclosed for forming the many other complex features that are typically required in actual fuel cell embodiments (e.g. fluid ports, backfeed ducts, transition regions, etc.) and no description is given regarding alternative means for providing the functions that these features provide.

To reduce costs, there remains a need for greater simplification in the manufacture of fuel cell stacks, and particularly for automotive applications. This invention fulfills these needs and provides further related advantages.

### SUMMARY

The present invention provides for methods of making complex bipolar plates for fuel cells, and particularly solid polymer electrolyte fuel cells, using extrusion as a primary manufacturing step. Desirable features in such bipolar plates include a variety of internal channels which fluidly connect to ports in the plates and/or other external features. However, such internal channels must otherwise be sealed against external leakage. Such features are quite complex and can only be formed in part via extrusion techniques. The present invention however employs a relatively simple set of manufacturing steps to complete the creation of these complex features. By using extrusion techniques, followed by this simple set of steps, the method allows for simpler, low cost manufacture of bipolar plates and fuel cell stacks comprising such plates.

Specifically, the method is for manufacturing a bipolar plate for a fuel cell in which the bipolar plate comprises fuel and oxidant flow fields on opposite surfaces of the bipolar plate and at least one channel internal to the bipolar plate for an operating fluid of the fuel cell. The method first comprises extruding an extrudable material to form a continuous sheet with linear channels on each surface of the sheet and at least one internal linear channel within the sheet. The method further comprises transversely cutting the sheet to form a plate, machining a fluid port through the sheet to intersect with the at least one internal linear channel, and machining at least two sealing ports through the sheet to intersect with the at least one internal linear channel on opposite sides of the fluid port. These steps may be performed in any reasonable order. And at some point after machining the sealing ports, the method comprises applying sealant into the sealing ports such that the at least one internal linear channel is sealed shut on opposite sides of the fluid port.

The method can be used to create bipolar plates comprising internal coolant flow fields, for instance embodiments in which the operating fluid is coolant, the at least one internal linear channel is a coolant channel, and the fluid port is a coolant port. Typically such bipolar plates comprise a plurality of internal linear coolant channels and two coolant ports. Such embodiments can thus comprise extruding the extrudable material to form the continuous sheet with a plurality of internal linear coolant channels within the sheet, machining two coolant ports through the sheet to intersect with the plurality of internal linear coolant channels such that the plurality of internal linear coolant channels between the two coolant ports defines a coolant flow field, and machining first and second sealing ports through the plate to intersect with the internal linear coolant channels on the sides of the coolant fluid ports away from the coolant flow field. In such embodiments, the first and second sealing ports would then serve as sealing ports on opposite sides of each coolant port.

Alternatively or in addition to the above, the method can be used to create bipolar plates comprising backfeed features, for instance embodiments in which the operating fluid is a reactant selected from the group consisting of fuel and oxidant, the linear channels on one surface of the sheet form a flow field for the reactant, the at least one internal channel is a backfeed channel for the reactant, and the fluid port is a port for the reactant. Such embodiments can comprise partially machining a backfeed pocket into the reactant flow field surface of the sheet between the reactant port and a first sealing port such that the backfeed pocket intersects with the reactant backfeed channel but does not penetrate through the sheet, and machining a transition region into the linear channels on the reactant flow field surface of the sheet such that the backfeed pocket is fluidly connected to the linear channels of the reactant flow field. To accomplish the necessary sealing, the first sealing port can be adjacent the backfeed pocket on the side away from the reactant port and a second sealing port can be adjacent the reactant port on the side away from the backfeed pocket.

Bipolar plates comprising backfeed features may typically include such features at several locations on the plate. Thus, embodiments can comprise machining an additional reactant port, additional sealing ports, an additional backfeed pocket, and an additional transition region at an opposite end of the plate to the reactant port, the first and second sealing ports, the backfeed pocket, and the transition region. In suitable such embodiments, it may additionally be desirable to machine out a portion of the sheet comprising the internal linear channel between the backfeed pocket and the additional backfeed pocket.

In certain preferred embodiments, the step of applying sealant to form a perimeter seal around a surface of the plate is performed concurrently with applying sealant into the sealing ports.

With regards to material selection for the extrudable material, various materials may be considered. An exemplary extrudable material for instance is a polymer composite filled with carbon or metal.

The method of the invention provides for simpler, lower cost production of bipolar plates. Fewer components and fewer manufacturing steps are required. Alignment issues and electrical losses associated with contact resistances in conventional two piece bipolar plate assemblies are avoided because the instant bipolar plate is made as a single piece. Thus, along with easier manufacture, fuel cell performance can be improved. And unlike conventional bipolar plate assemblies and particularly stamped metal plate assemblies, the reactant flow field channels in the instant bipolar plates may desirably be made with draft angles of zero degrees. In turn, this allows for improved fuel cell performance. And further, unlike conventional stamped metal bipolar plate assemblies, internal coolant flow field channel geometries may be formed that are independent of the geometries used for the reactant flow field channels. Thus, it can be possible to employ both a preferred design for the reactant flow field channels and a preferred design for the coolant flow field channels, without having to make a trade-off in that regard. These and other aspects of the invention are evident upon reference to the attached Figures and following detailed description.

### BRIEF DESCRIPTION OF THE DRAWINGS

FIG. 1 shows surface and edge views of an exemplary bipolar plate assembly of the prior art which is intended for use in a solid polymer electrolyte fuel cell stacks for automotive applications. In FIG. 1, view 1a shows the anode side surface, view 1b shows the edge, and view 1c shows the cathode side surface of the bipolar plate assembly.

FIGS. 2a to 2d show views of a representative plate after the extrusion and cutting operations during the manufacturing process. FIG. 2a shows an isometric view of the anode side of plate. FIG. 2b shows an edge view of the plate. FIGS. 2c and 2d show magnified views of FIG. 2b in the vicinity of the backfeed channel region and in the middle of the flow field region respectively.

FIG. 3 shows the plate after transition regions have been formed in the opposing plate surfaces.

FIG. 4 shows the plate after the various ports have been formed in the plate.

FIG. 5 shows the plate after waists have been formed in the plate.

FIG. 6 shows the plate after appropriate backfeed pockets and sealing ports have been formed in the plate.

FIGS. 7a and 7b show the finished bipolar plate with applied seal. FIG. 7b is an enlargement of FIG. 7a in the vicinity of the fuel outlet port and the oxidant outlet port.

FIGS. 8a to 8d shows sections of prior art bipolar plate assemblies and a section of a bipolar plate of the invention to schematically illustrate structural advantages of the latter. FIGS. 8a and 8c show sections of typical prior art bipolar plate assemblies made of carbonaceous flow field plates. FIG. 8b shows a section of a typical prior art bipolar plate assembly made of metal flow field plates. FIG. 8d shows a section of a bipolar plate of the invention.

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%.

“Carbonaceous” has its plain meaning, namely meaning consisting of or containing carbon. For instance, carbonaceous refers to objects that consist essentially only of carbon or that simply contain carbon such as carbon composites (e.g. a composite of carbon and plastic).

In this specification, “draft angle” qualitatively refers to the angle that a given channel wall makes with respect to the normal to the adjacent landing in a flow field. However, because channel walls are not straight lines and have varying shapes depending on the materials and forming methods used, it is determined empirically here for quantitative purposes. “Landing radius” qualitatively refers to the radius of the rounded corner between the channel wall and landing. In a like manner to “draft angle”, “landing radius” is also determined empirically. Herein, a Carl Zeiss Surfcom 1900 SDZ Contour and Surface measurement machine was used to determine the values in the Example below.

The present invention allows bipolar plates comprising complex features (particularly fluid ports which connect to channels internal to the bipolar plate) to be manufactured for fuel cells in a simple, low cost manner. The inventive bipolar plate can be manufactured as a single part using extrusion techniques. Further, the invention allows improved bipolar plates to be made in this general manner.

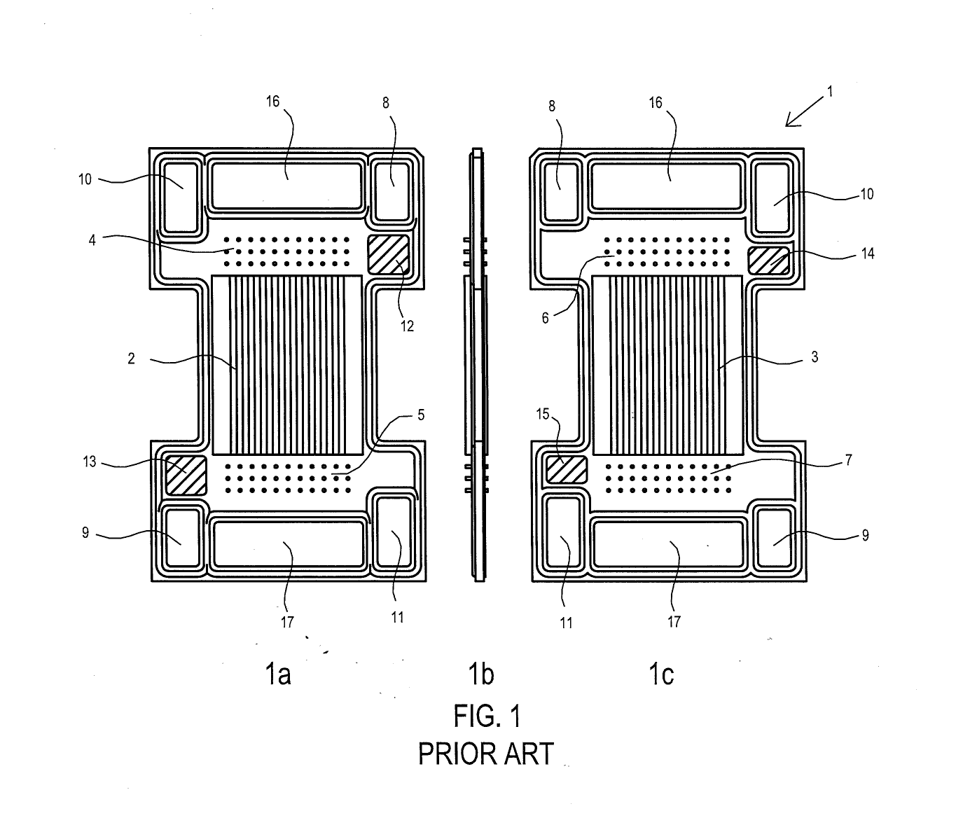

FIG. 1 shows an exemplary bipolar plate assembly in the prior art which might desirably be used in solid polymer electrolyte fuel cell stacks for automotive applications. Views 1a and 1c in this figure show the anode side surface and the cathode side surface of bipolar plate assembly 1 respectively. View 1b shows a view of the edge of bipolar plate assembly 1.

Bipolar plate assembly 1 comprises fuel flow field 2 and oxidant flow field 3 on the anode and cathode sides respectively. Each of these flow fields comprises a plurality of linear, parallel channels separated by landings. At each end of these flow fields are transition regions which here comprise a plurality of posts formed in the surfaces of the bipolar plate assembly. Specifically, these transition regions are fuel inlet transition region 4, fuel outlet transition region 5, oxidant inlet transition region 6, and oxidant outlet transition region 7. The transition regions fluidly connect the flow fields to ports formed in the bipolar plate assemblies. In an assembled fuel cell stack, the stacked ports form manifolds for distributing bulk fluids to and from the individual cells in the stack. In FIG. 1, the reactant ports are fuel inlet port 8, fuel outlet port 9, oxidant inlet port 10, and oxidant outlet port 11.

In the embodiment shown in FIG. 1, the reactant ports are connected to their respective flow fields using backfeed architecture. This architecture involves making fluid connections from the ports to the flow fields on the plate surfaces via ducts formed underneath the plate surface. Typically, these ducts are formed on the inner surfaces of the two plates making up bipolar plate assembly 1 and are thus not visible in FIG. 1. The backfeed ducts directly connect to their respective reactant port. Access to the plate surfaces is achieved by incorporating a set of additional ports that intersect the backfeed ducts. These additional ports only penetrate a single plate in the assembly and do not penetrate the entire assembly. Herein, these additional ports are referred to as backfeed pockets. In FIG. 1, bipolar plate assembly 1 comprises fuel inlet backfeed pocket 12, fuel outlet backfeed pocket 13, oxidant inlet backfeed pocket 14, and oxidant outlet backfeed pocket 15. These pockets are fluidly connected to ports 8, 9, 10, and 11 respectively via backfeed ducts not visible in FIG. 1.

Bipolar plate assembly 1 further comprises a coolant flow field which is located in the centre of the assembly. In a like manner to the backfeed ducts, the coolant flow field is typically formed on the inner surfaces of the two plates making up bipolar plate assembly 1 and thus it is also not visible in FIG. 1. And, in a like manner to the reactant flow fields, the coolant flow field also comprises a plurality of linear, parallel channels separated by landings.

Bipolar plates comprising complex features like those appearing in the bipolar plate assembly in FIG. 1 can be made as a single plate using extrusion techniques as illustrated in the following figures. Initially, a continuous sheet is extruded with a plurality of linear channels formed on each surface of the sheet along with a plurality of internal linear channels formed within the sheet. The continuous sheet is then transversely cut into appropriate lengths for the desired plate.

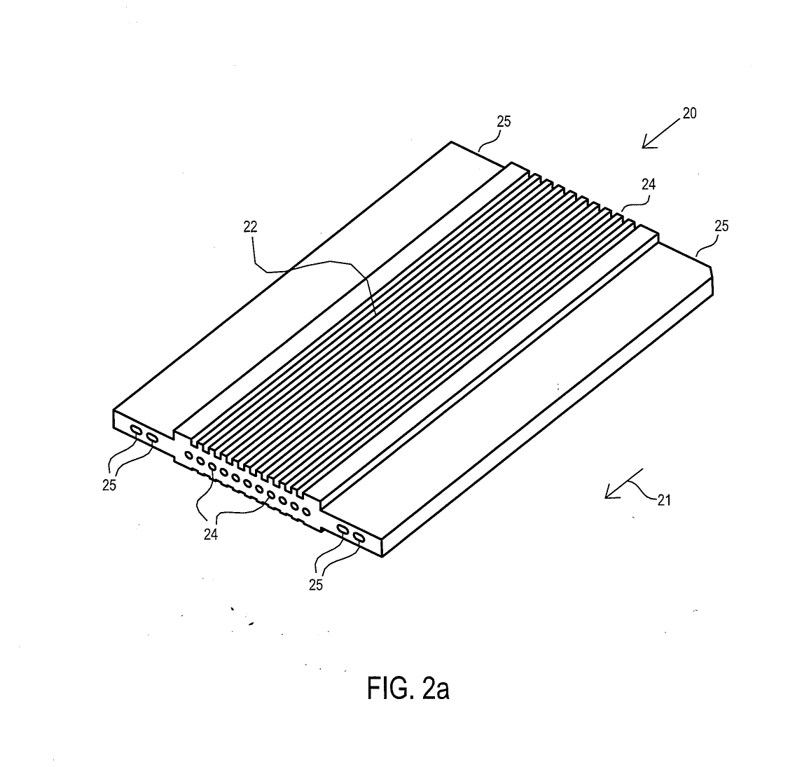

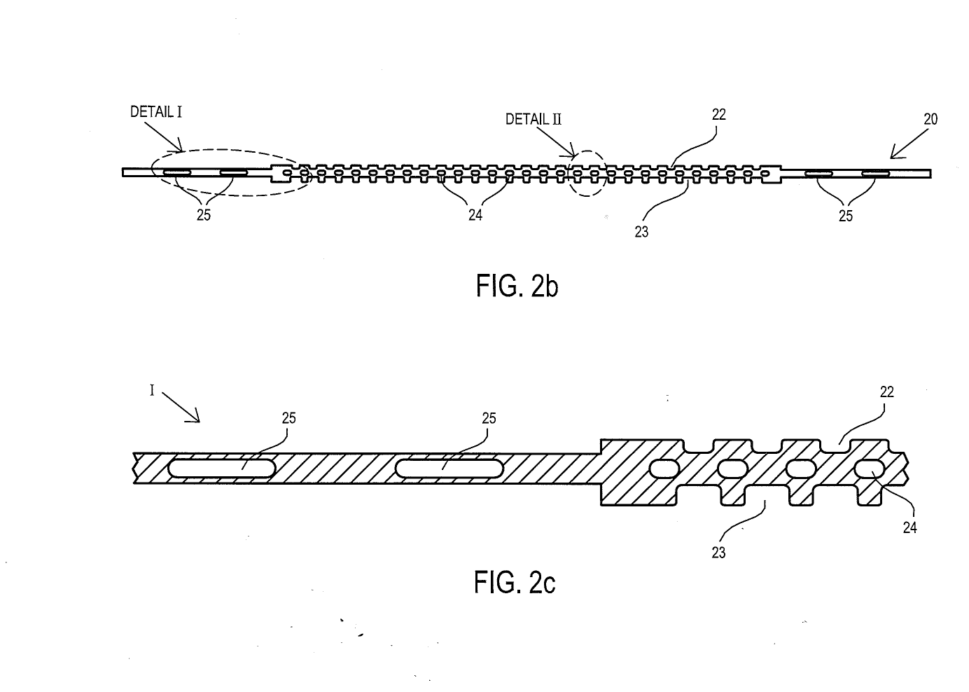

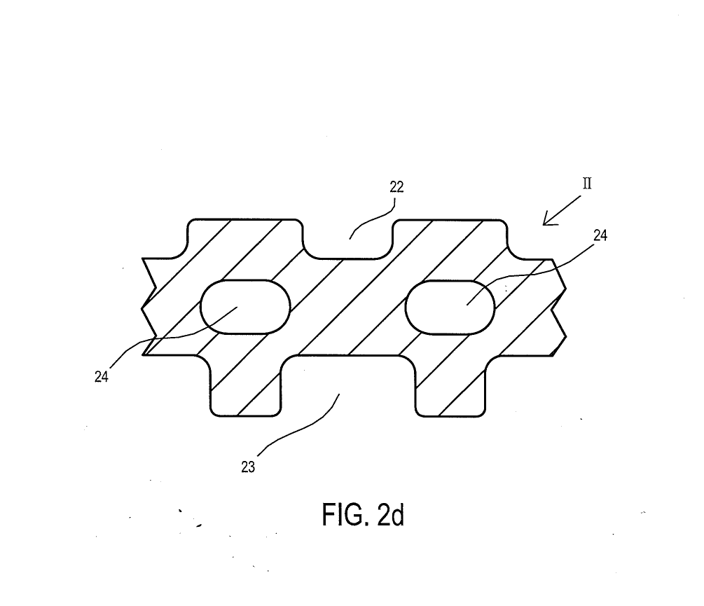

FIG. 2a shows an isometric view of a representative rectangular plate 20 after these extrusion and cutting operations. The extrusion direction is indicated by arrow 21. Visible on the top surface of plate 20 are linear channels 22 which will used to form the fuel flow field in plate 20. Linear channels for the oxidant flow field appear on the opposite surface and are not visible in FIG. 2a. Linear coolant channels 24 appear within the sheet which will be used to form the coolant flow field. In addition, linear backfeed channels 25 also appear within the sheet to be used in forming various backfeed ducts for the reactants (fuel and oxidant).

FIG. 2b shows an edge view of rectangular plate 20 and provides a better view of the profile of plate 20. FIGS. 2c and 2d show magnified views in the vicinity of backfeed channels 25 and in the middle of the plurality of channels 22, 23, and 24 respectively. FIG. 2c is a magnified view of Detail I in FIG. 2b. FIG. 2d is a magnified view of Detail II in FIG. 2b.

Rectangular plates 20 can be extruded and cut using a variety of techniques known to those in the art. The materials used to make the plate must be extrudable while still providing the final properties required for use as a plate in the harsh fuel cell environment. Blends of various metal and/or carbon particles in combination with certain polymers that are known to be compatible with the fuel cell environment may be considered. The type and amounts of each component are selected such that the blend is both acceptable for extrusion while producing an extrudate with acceptable mechanical, electrical, and chemical properties for use in fuel cells. Examples of suitable materials are extrudable carbon material and carbon filled plastics.

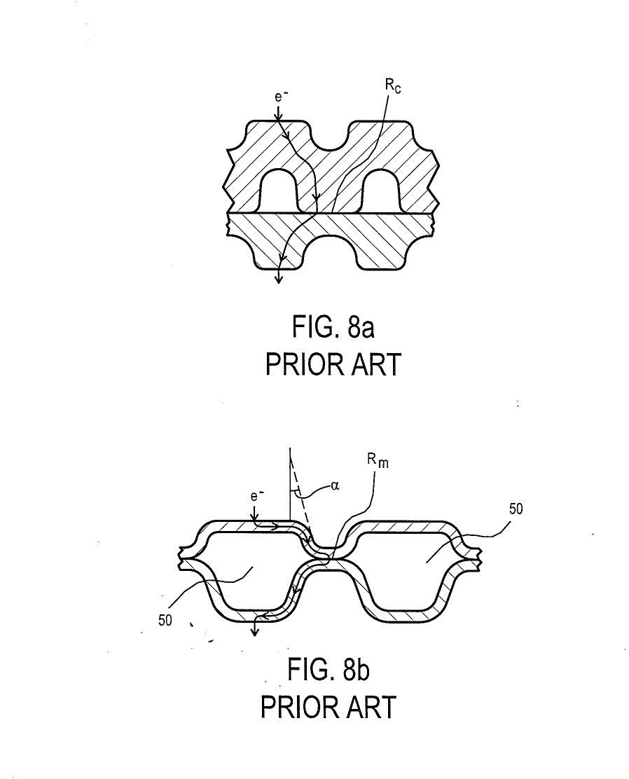

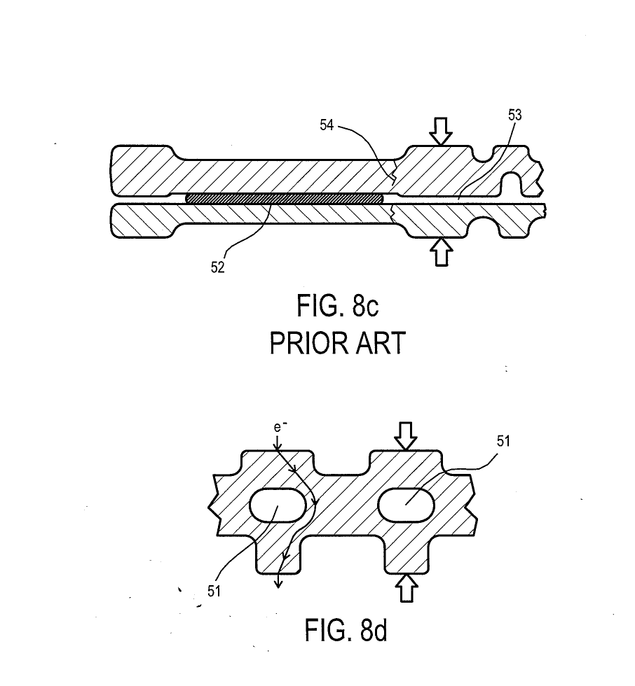

Unlike conventional bipolar plate assemblies, extruding the bipolar plate makes it practically possible to obtain several structural advantages. As discussed in more detail later, extruding the plate in a single piece not only reduces parts count and simplifies fuel cell stack assembly by obviating alignment and bonding steps of two component plates, but also eliminates any contact resistance problems between the two bonded plates in a conventional assembly. Further, the dimension and shape options available for coolant channels 24 are much more independent from those of fuel channels 22 and oxidant channels 23. This can be useful in optimizing the performance of the fuel cell stack. Further still, essentially any desired draft angle a (the angle between channel wall and the normal to the adjacent landing) can readily be obtained for both fuel and oxidant channels 22, 23. In plate 20 of FIG. 2d, the draft angles of both fuel channel 22 and oxidant channel 23 are 0° and thus are not easy to illustrate. (However, FIG. 8b illustrates a non-zero degree draft angle a for a channel in a typical bipolar plate assembly made of stamped metal plates.) As illustrated in the Example below, unexpected performance advantages may be obtained by using plates with channels having lower draft angles than what can be practically obtained in conventional bipolar plate assemblies. And further still, extruding the plate in a single piece eliminates the possibility of undesirable gaps which can exist between the two bonded plates in conventional bipolar plate assemblies.

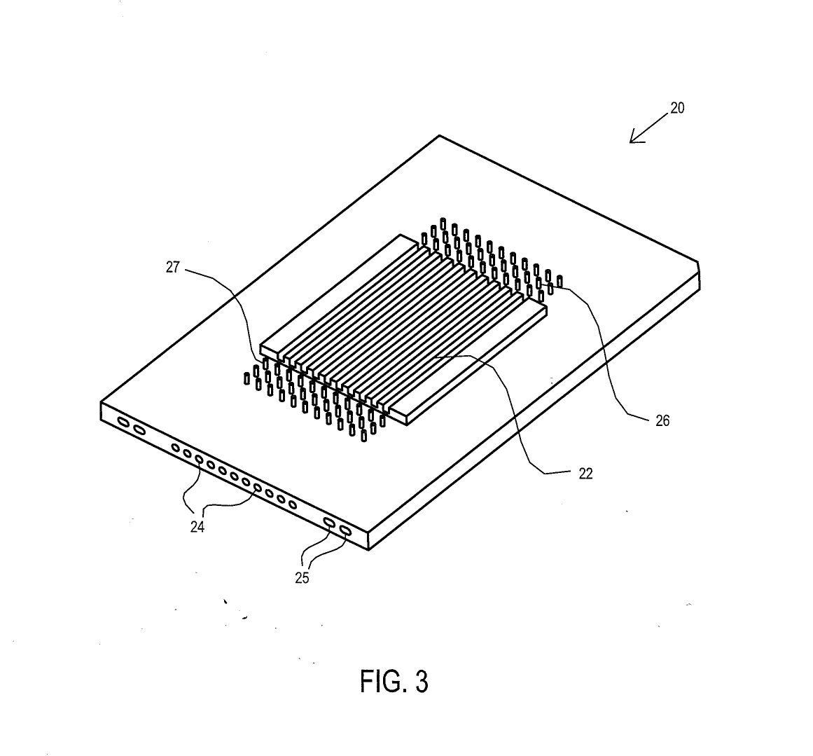

After extruding and cutting out plate 20, transition regions for the reactants may be formed in the opposing plate surfaces. In FIG. 3, fuel inlet transition region 26 and fuel outlet transition region 27 have been formed by machining away appropriate portions of linear channels 22 (e.g. via CNC milling).

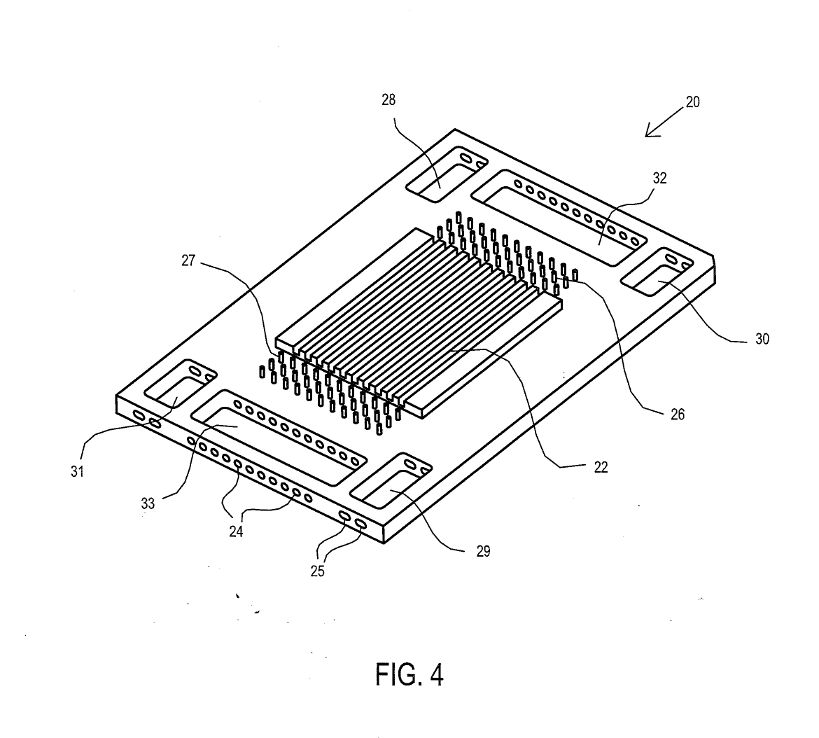

Next, the various required ports may be formed in plate 20 (e.g. again via CNC milling). In FIG. 4, oxidant inlet port 28, oxidant outlet port 29, fuel inlet port 30, fuel outlet port 31, coolant inlet port 32, and coolant outlet port 33 have been machined into plate 20. Note that oxidant inlet port 28, oxidant outlet port 29, fuel inlet port 30, and fuel outlet port 31 intersect with certain of backfeed channels 25, while coolant inlet port 32 and coolant outlet port 33 intersect with coolant channels 24.

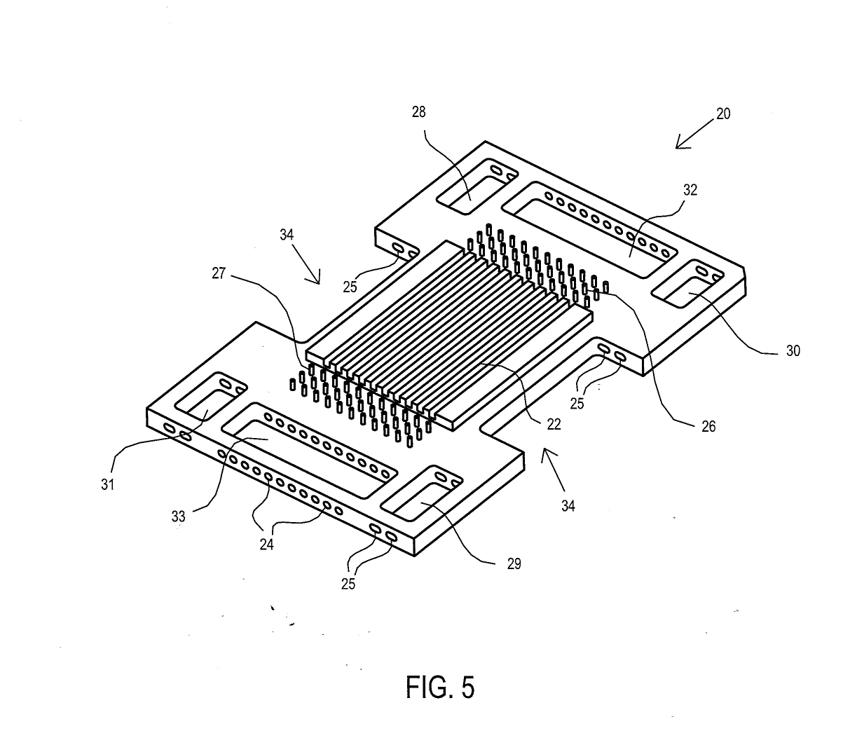

FIG. 5 now shows plate 20 with “waists” 34 machined out of the sides. The removal of this material desirably reduces mass. In addition though, it can also serve to improve the robustness of the plate to the possibility of fuel to oxidant leaks and mixing. For instance, if waists 34 are not machined into plate 20, then backfeed channels 25 would interconnect a fuel port to an oxidant port on each side of the plate (e.g. oxidant inlet port 28 would fluidly be connected to fuel outlet port 31 via backfeed channels 25). As will be apparent later in this description, the prevention of fuel to oxidant leaks along these pathways would solely be reliant on the seal material introduced later in the method to properly fill and seal backfeed channels 25. By providing waists 34, any such leak is now directed outside the fuel cell stack. While still undesirable, small such leaks are substantially less problematic than internal leaks which involve the direct mixing of the two reactants.

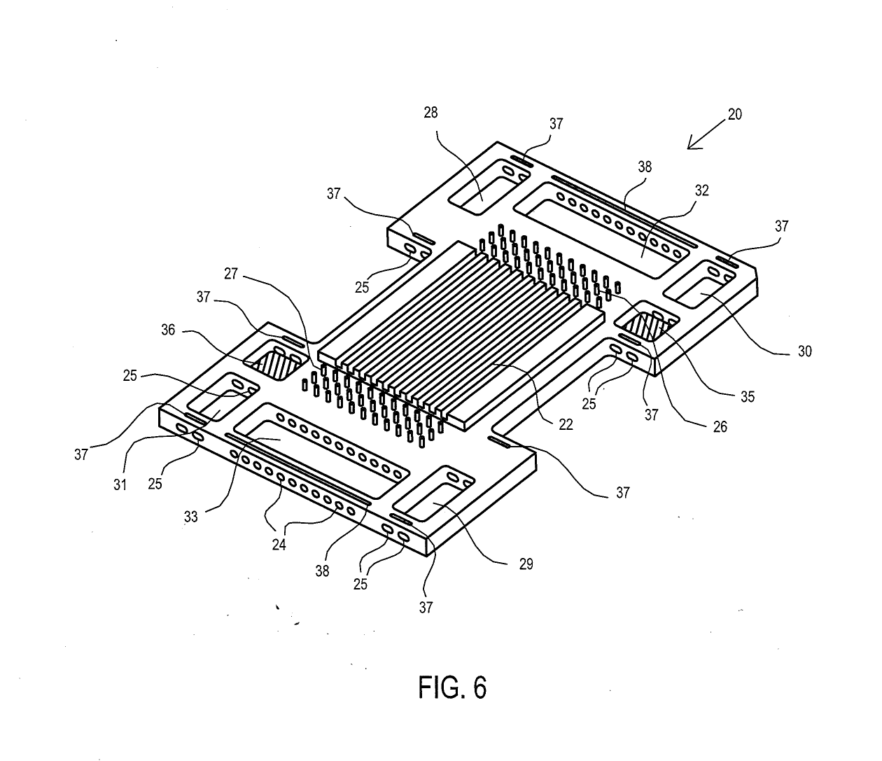

Next appropriate backfeed pockets and sealing ports may be formed in plate 20. FIG. 6 shows backfeed pocket 35 and 36 near fuel inlet port 30 and fuel outlet port 31 respectively. Backfeed pockets 35, 36 have been partially machined (e.g. again via CNC milling) into the fuel side of plate 20 such that they intersect backfeed channels 25 within the plate. In a like manner, backfeed pockets near fuel inlet port 28 and fuel outlet port 29 are partially machined into the oxidant side of plate 20 (not visible in FIG. 6). Each backfeed pocket thus fluidly connects to its adjacent port via backfeed channels 25. And, in an assembled fuel cell stack, these backfeed pockets provide pathways for reactant fluids to flow between the various ports and their associated transition regions in the bipolar plate.

FIG. 6 also shows sealing ports 37 which have been machined (e.g. again via CNC milling) through plate 20 on opposite sides of the various ports 28, 29, 30, 31. Sealing ports 37 intersect with backfeed channels 25. In addition, sealing ports 38 have been machined through plate 20 and intersect with coolant channels 24. The two sealing ports 38 shown in FIG. 6 are located on opposite sides of each of inlet and outlet coolant ports 32 and 33, and thus serve as sealing ports for both these coolant ports. In the next step of assembly, these various sealing ports allow injected seal material to access the middle and both sides of bipolar plate 20 and in particular they allow injected seal material to plug coolant channels 24 and backfeed channels 25 where desired. Surface treatments may then be performed if desired (e.g. to increase the electrical conductivity of the surface when certain materials are employed).

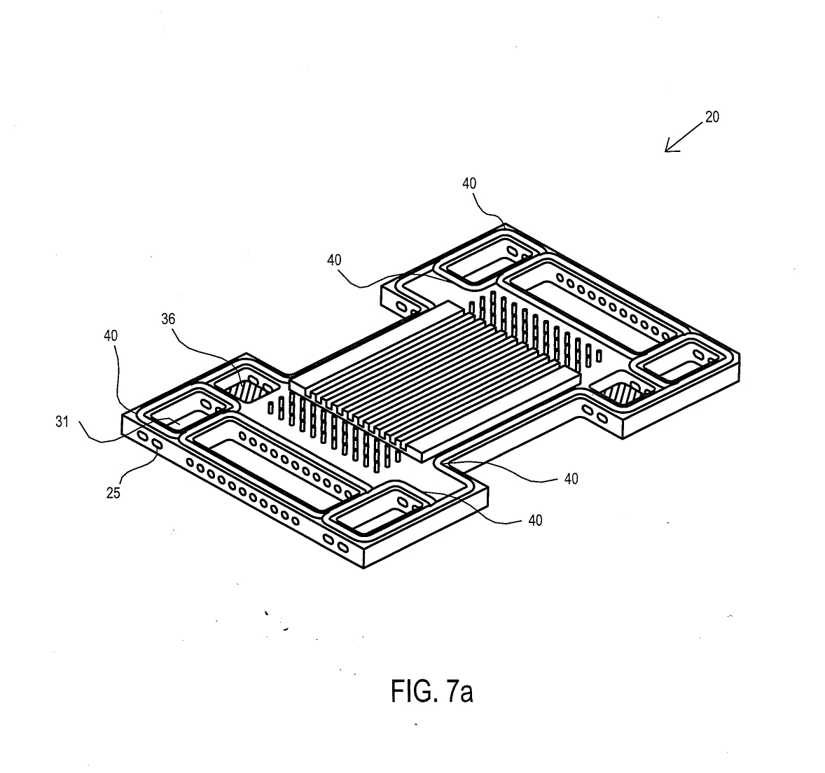

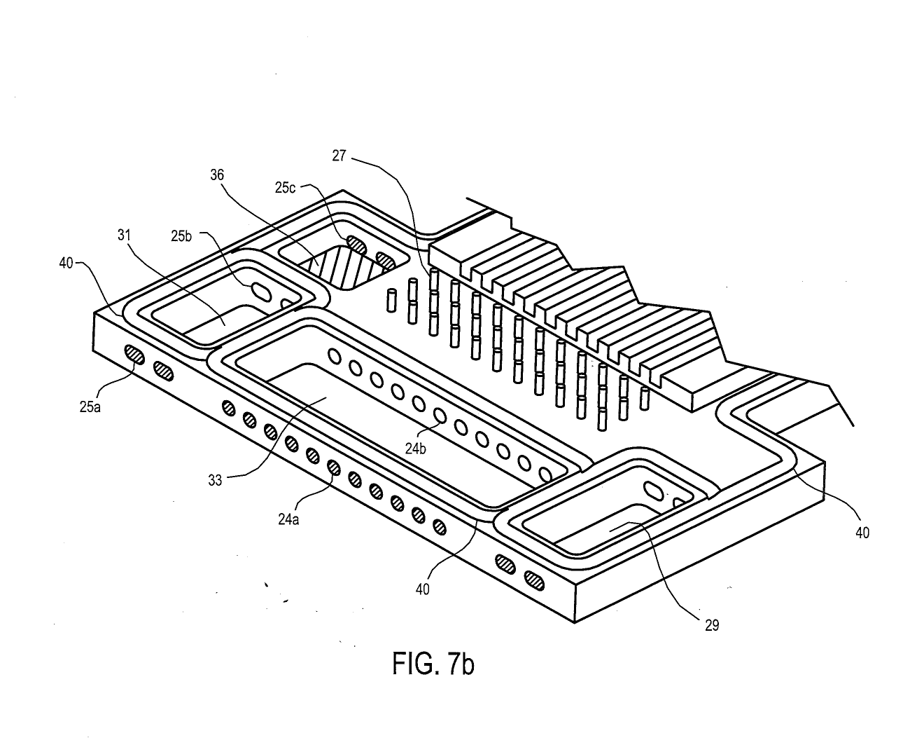

In a final step, appropriate seals are added to bipolar plate assembly. The seals are applied in liquid form (typically a silicone polymer precursor which is applied via liquid injection molding or LIM techniques), both into and onto the plate at desired locations, and then cured in place. FIGS. 7a and 7b show the finished bipolar plate 20 with applied seal 40. Finished bipolar plate 20 is essentially the same as conventional bipolar plate assembly 1 in FIG. 1.

FIG. 7b shows an enlarged view of plate 20 of FIG. 7a in the vicinity of fuel outlet port 31 and oxidant outlet port 29. As in the prior art, applied seal 40 provides the usual sealing functions in an assembled fuel cell stack. However, applied seal 40 also plugs and seals off coolant channels 24 and backfeed channels 25 in appropriate locations, and thereby completes the fabrication of the complex coolant flow field and backfeed features in bipolar plate 20. For instance, coolant channels 24a are plugged via the sealant which filled sealing port 38. However, coolant channels 24b (which serve as the coolant flow field within plate 20) are not plugged and can access coolant outlet port 33. Further, backfeed channels 25a and 25c are plugged via the sealant which filled sealing ports 37, thereby preventing leaks from oxidant outlet port 31 to the environment. However, backfeed channels 25b are not plugged and thus serve as backfeed ducts which fluidly connect fuel outlet port 31 to backfeed pocket 36, and in turn to fuel outlet transition region 27.

The method of the invention provides for improvements in both the manufacturing process and in the bipolar plate product itself. In manufacture, by extruding the bipolar plate as a single piece, the need to bond or weld together two component plates into an assembly is eliminated. Thus, the number of components is reduced and the number of assembly steps is reduced. The requirement for careful alignment of the two component plates while bonding or welding is eliminated. All these improvements result in substantial reductions in cost. In particular, the welding operations needed for conventional metal plate based bipolar plate assemblies can be very expensive. The present method eliminates these welding costs.

FIGS. 8a to 8d schematically illustrate some of the structural advantages provided by the invention. FIGS. 8a and 8c show sections of typical prior art bipolar plate assemblies made of two carbonaceous flow field plates. FIG. 8b shows a section of a typical prior art bipolar plate assembly made of two metal flow field plates. FIG. 8d shows a section of a bipolar plate of the invention for comparison. In all these figures, the upper plate or upper surface represents the anode plate or anode side, and the lower plate or lower surface represents the cathode plate or cathode side.

One advantage of the embodiments of the invention is the absence of the numerous contact resistances appearing in conventional bipolar plate assemblies. The location of the contact resistances in prior art carbonaceous and metal plate assemblies are indicated by Rc and Rm respectively in FIGS. 8a and 8b respectively. The flow of an electron from the upper plate to the lower plate is illustrated schematically in both figures. There are numerous such locations in prior art assemblies and obtaining sufficiently good electrical connections between both plates can at times be problematic. The inventive embodiment of FIG. 8d has no such contact resistance issue.

A further advantage of the inventive embodiments is that the draft angles of the reactant channels can readily be made at any angle, in particular at zero degrees (or even less). In prior art carbonaceous and metal bipolar plate assemblies, there are limitations as to how small the draft angles can be made in practice. FIG. 8b shows the non-zero degree draft angle a for a channel in a typical bipolar plate assembly made of stamped metal plates. Limitations associated with the plates used and the stamping process itself result in a relatively large draft angle minimum in practice (e.g. 20° or so). The minimum draft angle that can be obtained in typical embossed carbonaceous plates is somewhat lower (e.g. 4° or so), but lower angles cannot be achieved in practice. (FIG. 8a shows the profile of carbonaceous plates as they appear in a typical prior art bipolar plate assembly.) However, as illustrated in the Example below, performance advantages may be obtained when using even smaller draft angles. These performance advantages can thus be obtained using the present inventive method, because these bipolar plates can be made with any draft angle (e.g. 0°). Further, it is believed that performance advantages may be obtained when using smaller radii for the landings. The present invention also allows for smaller radii than typical prior art embodiments.

A yet further advantage of the invention is that more options are available for the coolant channel geometry. This is particularly true compared to metallic bipolar plate assemblies in which the coolant channel geometry is essentially the complement of the reactant channel geometries (since these assemblies are formed by stamping two uniform sheets). In present conventional metallic bipolar plate assemblies, the coolant channels may necessarily be larger than desired when certain reactant channel geometries are selected or required. For instance, compare the geometry of coolant channels 50 in FIG. 8b to that of coolant channels 51 in the extruded inventive embodiment in FIG. 8d.

Further still, extruding the plate in a single piece eliminates the possibility of undesirable gaps which can exist between the two bonded plates in conventional bipolar plate assemblies. In carbonaceous assemblies in particular, gaps arising from tolerance issues or uneven/improper distribution of the bonding adhesive can lead to cracking in the plates. FIG. 8c illustrates this problem. Here, bonding adhesive 52 has been unevenly applied between the two plates, with the result that gap 53 exists between the plates in the vicinity of a channel. When force is applied to the landings in an assembled fuel cell stack (this force is indicated by large arrows in FIGS. 8c and 8d), cracks 54 can arise from excessive bending stress resulting from the presence of gap 53. However, there is no possibility of having such undesirable gaps in the embodiment of FIG. 8d given the way it has been produced.

The preceding advantages all contribute to improved fuel cell performance and/or reliability. Thus, the method of the invention can provide noticeable improvements to product fuel cells and stacks as well as to the manufacturing process of the bipolar plates.

The following example illustrates that certain benefits may be achieved when using the invention, but this should not be construed as limiting in any way.

### EXAMPLE

Illustrative Example Showing Effect of Oxidant Channel Features

Several solid polymer electrolyte fuel cell stacks of conventional construction for automotive use were made, in some cases with metal bipolar plate assemblies and in other cases with carbonaceous bipolar plate assemblies. With the possible exception of the oxidant flow field channel shapes (particularly landing radii and draft angles), the dimensions of the oxidant flow fields and other dimensions in the two different assemblies were similar enough (but not identical) that no significant difference in performance was expected between the two assemblies. Yet in certain tests at current densities of 1.7 and 2.4 A/cm², the cell stacks with carbonaceous bipolar plate assemblies provided average output cell voltages about 50 and 100 mV higher respectively than the cell stacks with metal bipolar plate assemblies. This represented a significant performance difference.

To investigate the effect of landing radius and draft angle differences in the oxidant flow field channels, CFD (computational fluid dynamics) simulations were performed on oxidant flow field plates having the channel shapes depicted schematically in FIGS. 8a and 8b. These figures show cross sectional profiles of the typical oxidant channels found in carbon/plastic composite and metal plates respectively. In these simulations, both had similar hydraulic diameters. However, the oxidant channel landing radius in the carbonaceous oxidant flow field plate was 0.08 mm and the draft angle was 4°. And the oxidant channel landing radius in the metal oxidant flow field plate was 0.25 mm and the draft angle was 20°. In CFD simulations with the same oxidant supply provided to each, it was found that the shape in the carbonaceous oxidant flow field plate provided for substantially better oxidant flow velocity, oxygen concentration, and diffusion flux in the vicinity of the landing edges and in the GDL adjacent the landings. Without being bound by theory, it is believed that the performance difference between cell stacks with metal and carbonaceous bipolar plate assemblies arises from oxidant mass transport differences in the GDLs under the adjacent landings. And in turn, these differences are believed to result from differences in the oxidant channel shapes.

It is thus believed that lower values for both landing radii and draft angle in such plates are required in order to obtain the best fuel cell performance. The present invention allows for bipolar plates to be produced with even lower values than this, in a simple and cost effective manner.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

What is claimed is:

1. A method of manufacturing a bipolar plate for a fuel cell, the bipolar plate comprising fuel and oxidant flow fields on opposite surfaces of the bipolar plate and at least one channel internal to the bipolar plate for an operating fluid of the fuel cell, the method comprising:
extruding an extrudable material to form a continuous sheet with linear channels on each surface of the sheet and at least one internal linear channel within the sheet;
transversely cutting the sheet to form a plate;
machining a fluid port through the sheet to intersect with the at least one internal linear channel;
machining at least two sealing ports through the sheet to intersect with the at least one internal linear channel on opposite sides of the fluid port; and
applying sealant into the sealing ports such that the at least one internal linear channel is sealed shut on opposite sides of the fluid port.

2. The method of claim 1 wherein the operating fluid is coolant, the at least one internal linear channel is a coolant channel, and the fluid port is a coolant port.

3. The method of claim 2 comprising:
extruding the extrudable material to form the continuous sheet with a plurality of internal linear coolant channels within the sheet;
machining two coolant ports through the sheet to intersect with the plurality of internal linear coolant channels such that the plurality of internal linear coolant channels between the two coolant ports defines a coolant flow field; and
machining first and second sealing ports through the plate to intersect with the internal linear coolant channels on the sides of the coolant fluid ports away from the coolant flow field, whereby the first and second sealing ports serve as sealing ports on opposite sides of each coolant port.

4. The method of claim 1 wherein the operating fluid is a reactant selected from the group consisting of fuel and oxidant, the linear channels on one surface of the sheet form a flow field for the reactant, the at least one internal channel is a backfeed channel for the reactant, and the fluid port is a port for the reactant.

5. The method of claim 4 comprising:
partially machining a backfeed pocket into the reactant flow field surface of the sheet between the reactant port and a first sealing port such that the backfeed pocket intersects with the reactant backfeed channel but does not penetrate through the sheet; and
machining a transition region into the linear channels on the reactant flow field surface of the sheet such that the backfeed pocket is fluidly connected to the linear channels of the reactant flow field.

6. The method of claim 5 wherein the first sealing port is adjacent the backfeed pocket on the side away from the reactant port and a second sealing port is adjacent the reactant port on the side away from the backfeed pocket.

7. The method of claim 6 comprising:
machining an additional reactant port, additional sealing ports, an additional backfeed pocket, and an additional transition region at an opposite end of the plate to the reactant port, the first and second sealing ports, the backfeed pocket, and the transition region.

8. The method of claim 7 comprising:
machining out a portion of the sheet comprising the internal linear channel between the backfeed pocket and the additional backfeed pocket.

9. The method of claim 1 comprising:
applying sealant to form a perimeter seal around a surface of the plate concurrently with applying sealant into the sealing ports.

10. The method of claim 1 wherein the extrudable material is a polymer composite filled with carbon or metal.

11. The method of claim 1 wherein the fuel cell is a solid polymer electrolyte fuel cell.

12. A bipolar plate for a fuel cell manufactured according to the method of claim 1.
